(19) United States
(12) Patent Application Publication
(10) Pub. No.: US 2022/0044063 A1
(43) Pub. Date: Feb. 10, 2022

(54) POULTRY RAISING SYSTEM, POULTRY RAISING METHOD, AND RECORDING MEDIUM

(71) Applicant: Panasonic Intellectual Property Management Co., Ltd., Osaka (JP)

(72) Inventors: Yasuko YAMAMOTO, Osaka (JP); Shingo NAGATOMO, Osaka (JP); Mamoru OZAKI, Osaka (JP)

(21) Appl. No.: 17/296,332

(22) PCT Filed: Nov. 5, 2019
(86) PCT No.: PCT/JP2019/043189

§ 371 Date: May 24, 2021

(30) Foreign Application Priority Data
Nov. 29, 2018 (JP) 2018-223042

(51) Int. Cl. G06K 9/62; A01K 29/00; A01K 45/00

(52) U.S. Cl. CPC G06K 9/6212; G06K 9/6202; A01K 45/00; A01K 29/00

(57) ABSTRACT

A poultry raising system (10) includes: an imager (21) that captures an image of an inside of a poultry house; a monitor (32a) that monitors a feature quantity of chickens in the poultry house, the feature quantity being obtained by performing image processing on the image captured by the imager (21); and a calculator (32b) that calculates, based on information indicating a state of growth of the chickens in the poultry house, a threshold used for providing a notification about the chickens in the poultry house, the notification being provided based on the feature quantity.

### TECHNICAL FIELD

The present invention relates to a poultry raising system used in a poultry house etc.

### BACKGROUND ART

Poultry raising is a popular industry in many countries of the world including Japan. As a technique related to poultry raising, Patent Literature (PTL) 1 discloses the automatic mortality rate determination method for automatically determining the mortality rate of chickens from an image captured by a thermograph.

### CITATION LIST

### Patent Literature

[PTL 1] Japanese Unexamined Patent Application Publication No. 2006-50989

### SUMMARY OF INVENTION

### Technical Problem

The poultry raising system capable of providing a notification about chickens in a poultry house has a problem of increasing the accuracy of the notification.

The present invention provides a poultry raising system, a poultry raising method, and a program which are capable of increasing the accuracy of a notification about chickens in a poultry house.

### Solution to Problem

A poultry raising system according to an aspect of the present invention includes: an imager that captures an image of an inside of a poultry house; a monitor that monitors a feature quantity of chickens in the poultry house, the feature quantity being obtained by performing image processing on the image captured by the imager; and a calculator that calculates, based on information indicating a state of growth of the chickens in the poultry house, a threshold used for providing a notification about the chickens in the poultry house, the notification being provided based on the feature quantity.

A poultry raising method according to an aspect of the present invention includes: capturing an image of an inside of a poultry house; monitoring a feature quantity of chickens in the poultry house, the feature quantity being obtained by performing image processing on the image captured; and calculating, based on information indicating a state of growth of the chickens in the poultry house, a threshold used for providing a notification about the chickens in the poultry house, the notification being provided based on the feature quantity.

A program according to an aspect of the present invention is a program for causing a computer to execute the poultry raising method.

### Advantageous Effects of Invention

A poultry raising system, a poultry raising method, and a program according to the present invention are capable of increasing the accuracy of a notification about chickens in a poultry house.

### BRIEF DESCRIPTION OF DRAWINGS

FIG. 1 is a diagram schematically illustrating a poultry raising system according to an embodiment.

FIG. 2 is a block diagram illustrating a function configuration of the poultry raising system according to the embodiment.

FIG. 3 is a flowchart illustrating a first monitoring operation.

FIG. 4A is a diagram illustrating an example of an image of an inside of the poultry house which is captured by an imager,

FIG. 4B is a diagram illustrating another example of an image of the inside of the poultry house which is captured by the imager,

FIG. 5 is a diagram illustrating an example of an image showing that a state of feed consumption has worsened.

FIG. 6 is a flowchart illustrating a second monitoring operation.

FIG. 7 is a diagram illustrating various states of chickens in the poultry house,

FIG. 8 is a diagram illustrating a time variation of a density deviation and an amount of activity.

FIG. 9 is a diagram schematically illustrating a waterer,

FIG. 10 is a diagram schematically illustrating a poultry raising system that includes a plurality of imaging devices.

FIG. 11 is a flowchart illustrating calculation operation 1 for calculating a threshold.

FIG. 12 is a diagram illustrating a relation between an age in days and a first threshold.

FIG. 13 is a diagram illustrating a relation between an age in days and a second threshold.

FIG. 14 is a flowchart illustrating calculation operation 2 for calculating a threshold.

FIG. 15 is a diagram illustrating an example of weight information.

FIG. 16 is a diagram illustrating a relation between a reference weight and a first threshold.

FIG. 17 is a diagram illustrating a relation between a reference weight and a second threshold.

FIG. 18 is a flowchart illustrating calculation operation 3 for calculating a threshold.

FIG. 19 is a flowchart illustrating calculation operation 4 for calculating a threshold.

FIG. 20 is a plan view illustrating the inside of the poultry house viewed from the above.

FIG. 21 is a flowchart illustrating calculation operation 5 for calculating a threshold.

### DESCRIPTION OF EMBODIMENTS

Hereinafter, embodiments will be described with reference to the drawings. Note that the embodiments below each describe a general or specific example. The numerical values, shapes, materials, structural elements, the arrangement and connection of the structural elements, steps, and the order of the steps, etc. described in the following embodiments are mere examples, and thus are not intended to limit the present invention. Furthermore, among the structural elements in the following embodiments, those not recited in any of the independent claims representing the most generic concepts are described as optional structural elements.

Note that the drawings are schematic diagrams, and do not necessarily provide strictly accurate illustration. Throughout the drawings, the same numeral is given to substantially the same element, and redundant description is omitted or simplified.

### Embodiment

### [Configuration]

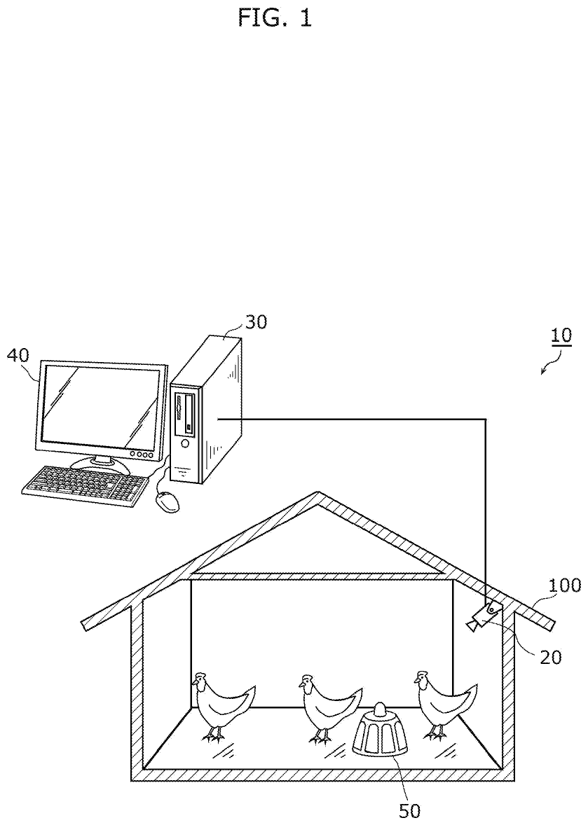

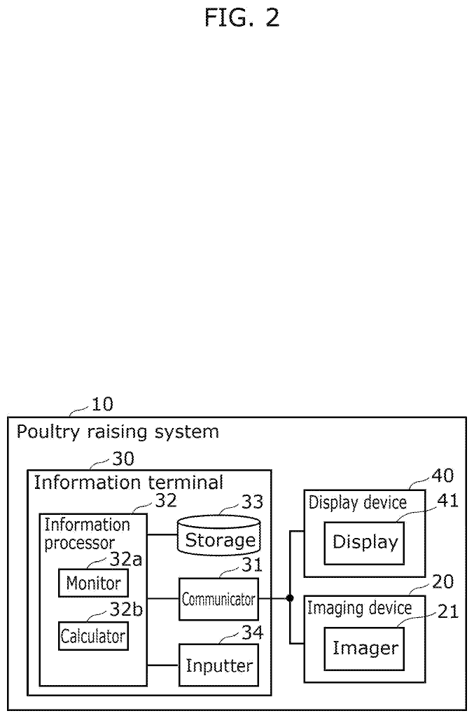

First, the configuration of a poultry raising system according to an embodiment will be described. FIG. 1 is a diagram schematically illustrating a poultry raising system according to an embodiment. FIG. 2 is a block diagram illustrating a function configuration of the poultry raising system according to the embodiment.

As illustrated in FIG. 1, poultry raising system 10 according to the embodiment is provided in, for example, poultry house 100, Chickens raised in poultry house 100 are broiler chickens (more specifically, Chunky, Cobb, Arbor Acres, etc.), but may be other breeds of chickens, such as the so-called locally produced chickens. Poultry house 100 includes feeder 50, a waterer (not illustrated), etc.

Poultry raising system 10 monitors a state of feed consumption of chickens in poultry house 100 by processing an image of an inside of poultry house 100 which is captured by imaging device 20. When it is determined that the state of feed consumption of the chickens has worsened, an image for providing a notification that the state of feed consumption has worsened is displayed on display device 40, That is, a manager of poultry house 100 is notified that the state of feed consumption has worsened via display device 40. With this, the manager of poultry house 100 can efficiently increase the body weight of the chickens by improving the state of feed consumption.

Specifically, poultry raising system 10 includes imaging device 20, information terminal 30, and display device 40 as illustrated in FIG. 1 and FIG. 2. Hereinafter, each of the devices will be described in detail.

### [Imaging Device]

Imaging device 20 captures an image of an inside of poultry house 100, Imaging device 20 is, for example, provided on a ceiling of poultry house 100, Imager 21 captures an image showing the inside of poultry house 100 which is captured from the above. The image here means a still image. Imaging device 20 constantly captures a dynamic image that consists of, for example, a plurality of images (i.e., frames). Imaging device 20 includes imager 21,

Imager 21 is an imaging module that includes an image sensor and an optical system (a lens, etc.) that guides light to the image sensor. Specifically, the image sensor is a complementary metal oxide semiconductor (CMOS) sensor, a charge coupled device (CCD) sensor, etc. An image captured by imager 21 is processed by information terminal 30 for monitoring the state of feed consumption of chickens in poultry house 100.

### [Information Terminal]

Information terminal 30 is an information terminal used by, for example, a manager of poultry house 100. Information terminal 30 monitors the state of feed consumption of chickens in poultry house 100 by processing an image of the inside of poultry house 100 which is captured by imaging device 20, Information terminal 30 is, for example, a personal computer, but may be a smartphone or a tablet terminal. In addition, information terminal 30 may be a device exclusively used for poultry raising system 10. Specifically, information terminal 30 includes communicator 31, information processor 32, storage 33, and inputter 34,

Communicator 31 is an example of an obtainer. Communicator 31 obtains an image captured by imager 21 included in imaging device 20. In addition, under the control of monitor 32a, communicator 31 transmits, to display device 40, image information for displaying an image showing that the state of feed consumption has worsened,

Specifically, communicator 31 is a communication module which performs wired or wireless communication. The communication module is, in other words, a communication circuit. The communication method employed by communicator 31 is not particularly limited. Communicator 31 may include two types of communication modules for communicating with each of imaging device 20 and display device 40. In addition, a relay device, such as a router, may be interposed between communicator 31, and imaging device 20 and display device 40.

Information processor 32 performs information processing for monitoring the state of feed consumption of chickens in poultry house 100. Specifically, information processor 32 may be implemented by a microcomputer. However, information processor 32 may be implemented by a processor or a dedicated circuit, Information processor 32 may be implemented by a combination of at least two of the microcomputer, the processor, and the dedicated circuit. Specifically, information processor 32 includes monitor 32a and calculator 32b.

Monitor 32a monitors a feature quantity of chickens in poultry house 100 which is obtained by performing information processing on an image obtained by communicator 31 for monitoring the state of feed consumption of the chickens in poultry house 100. Specifically, monitor 32a monitors the state of feed consumption of the chickens in poultry house 100 by regularly or periodically performing at least one of a first monitoring operation and a second monitoring operation, which will be described later. Note that a feature quantity in the first monitoring operation is a density deviation, and a feature quantity in the second monitoring operation is an amount of activity.

Calculator 32b calculates a threshold (a first threshold or a second threshold, which will be described later) based on information indicating a state of growth of chickens in poultry house 100. The threshold is used for providing a notification about the chickens in poultry house 100. The notification is provided based on the feature quantity monitored by monitor 32a, Note that a method of calculating a threshold which is employed by calculator 32b will be described later in detail.

Storage 33 stores a control program that is executed by information processor 32. In addition, storage 33 stores, for example, a threshold which is used for determination of the state of feed consumption. Storage 33 is implemented by, for example, a semiconductor memory.

Inputter 34 is a user interface device that receives an input by, for example, a manager of poultry house 100, Inputter 34 is implemented by, for example, a mouse and a keyboard. Inputter 34 may be implemented by a touch panel etc.

### [Display Device]

Display device 40 displays an image to notify a manager or the like of poultry house 100 of a state of feed consumption of chickens in poultry house 100. Display device 40 includes display 41. Display 41 displays an image based on image information transmitted from communicator 31. Display 41 is an example of a notifier. Display 41 displays an image to notify a manager or the like of poultry house 100 that the state of feed consumption has worsened.

Specifically, display device 40 is, for example, a monitor of a personal computer, but display device 40 may be a smartphone or a tablet terminal. When information terminal 30 is a smartphone etc., information terminal 30 may include display 41, instead of display device 40 including display 41, Specifically, display 41 is implemented by a liquid crystal panel or an organic electroluminescent (EL) panel

Note that it is not essential to use an image to notify a manager or the like of poultry house 100 that the state of feed consumption has worsened. It is possible to use a sound to provide a notification that the state of feed consumption has worsened. In this case, poultry raising system 10 is to include, as a notifier, a sound outputter, such as a speaker, instead of display 41.

### [First Monitoring Operation]

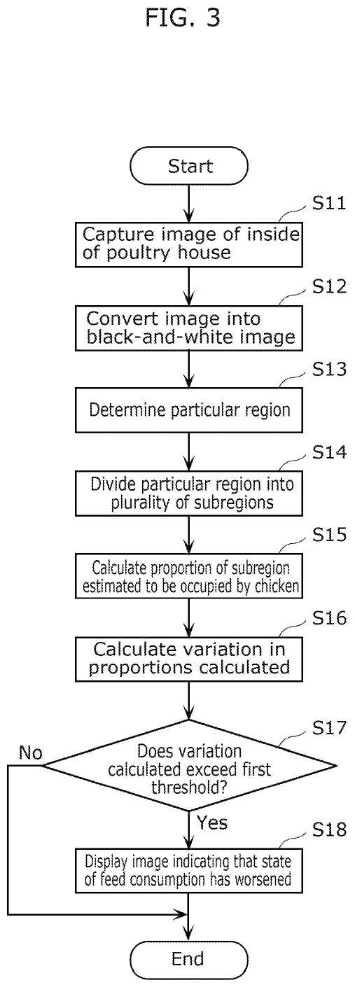

It is considered that the state of feed consumption is good when chickens are crowding around feeders 50 in poultry house 100. Accordingly, poultry raising system 10 monitors the crowding state of the chickens around feeders 50, Hereinafter, such a first monitoring operation will be described in detail. FIG. 3 is a flowchart illustrating the first monitoring operation.

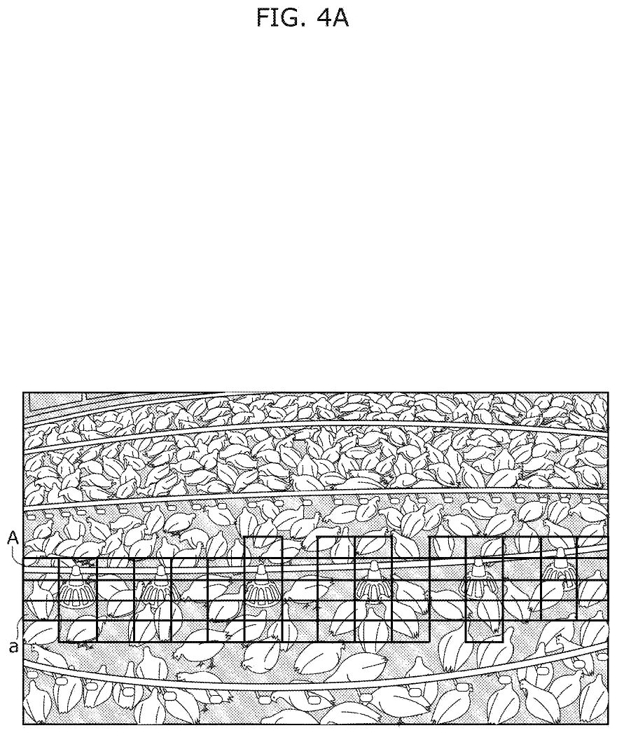

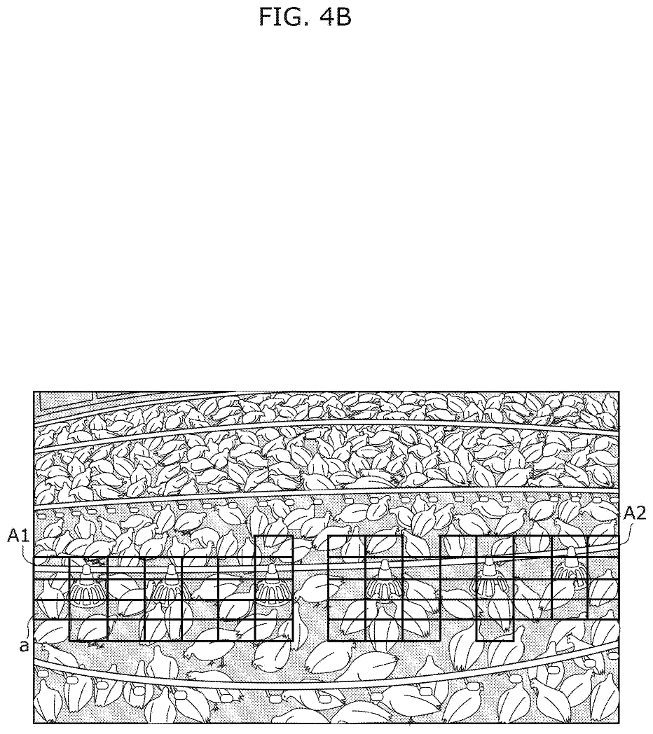

First, imager 21 of imaging device 20 captures an image of an inside of poultry house 100 (S11). FIG. 4A is a diagram illustrating an example of an image of the inside of poultry house 100 which is captured by imager 21.

Next, monitor 32a of information terminal 30 obtains the image of the inside of poultry house 100 which is captured by imager 21, and converts the obtained image into a black-and-white image (S12), When the image captured by imager 21 is a color image, monitor 32a converts the obtained color image into a grayscale image. A pixel value of each of a plurality of pixels included in the grayscale image is compared with a threshold for converting the grayscale image into a binary image. That is, monitor 32a converts the grayscale image into a black-and-white image. The black-and-white image is an image having a plurality of pixels each of which is either black or white. The black-and-white image is, in other words, an image that is captured by imager 21 and is converted into a binary image.

Since chickens have a white body, a portion that is white in the black-and-white image is a portion in which at least a chicken is estimated to be present. Since determination of the crowding state of chickens around feeders 50 is the aim of the first monitoring operation, it is possible to increase the accuracy of determination of the crowding state by drawing a distinction between a portion in which at least a chicken is present and the other portions. Accordingly, a threshold used for converting an image into a binary image is appropriately determined such that the portion in which the at least a chicken is present is to be selectively determined to be white. In addition, feeders 50 etc. that are provided inside poultry house 100 may have a color that is likely to be black when an image is converted into a binary image. That is, feeder 50 may have a color different from the color of chickens.

Next, monitor 32a determines a particular region that is at least part of the black-and-white image (S13). Specifically, the particular region is part of the black-and-white image and includes a portion in which at least feeder 50 is captured. FIG. 4A exemplifies particular region A that is long, is around feeders 50, and extends along the horizontal direction of an image. In FIG. 4A, a region around feeders 50 is selectively determined to be particular region A. Note that a particular region may be divided into a plurality of particular regions. FIG. 4B is a diagram illustrating an example of an image of the inside of poultry house 100 which is captured by imager 21 in the case in which a particular region is divided into a plurality of regions. FIG. 4B illustrates particular region A2 in addition to particular region A1. Determination as to which portion of an image is to be a particular region is empirically or experimentally made by, for example, an installer at the time of installing imaging device 20. When a capturing area captured by imager 21 is small, the entirety of the image may be a particular region.

Next, monitor 32a divides the particular region into a plurality of subregions (S14). FIG. 4A (or FIG. 4B) exemplifies subregions each of which has the shape of a quadrilateral and which is obtained by dividing the particular region into a grid-shaped pattern. Determination of a method of dividing the particular region (the size of a subregion, the number of times of dividing a particular region, etc.) is empirically or experimentally made by, for example, the installer etc.

Next, monitor 32a calculates, for each of the plurality of subregions, the proportion of the subregion estimated to be occupied by at least a chicken (S15). Specifically, monitor 32a calculates, as the proportion of the subregion estimated to be occupied by at least a chicken, the proportion of the area size of a white portion in the entire subregion. More specifically, monitor 32a calculates the proportion of the area size of the white portion by dividing the total number of white pixels included in the subregion by the total number of pixels included in the entire subregion.

Next, monitor 32a calculates a variation in the calculated proportions of the subregions each of which is estimated to be occupied by at least a chicken (S16). In other words, monitor 32a determines a spatial variation in the density of chickens present in the particular region. The variation here is specifically a standard deviation, but may be a variance. Hereinafter, the variation in the calculated proportions of the subregions each of which is estimated to be occupied by at least a chicken will also be indicated as a density deviation.

A state in which the density deviation is comparatively small means that the state of feed consumption is favorable. According to experiments conducted by the inventors, the body weight of chickens can be efficiently increased by maintaining the state in which the density deviation is comparatively small. Accordingly, monitor 32a determines whether the density deviation (that is, the variation calculated in step S16) exceeds a first threshold (S17).

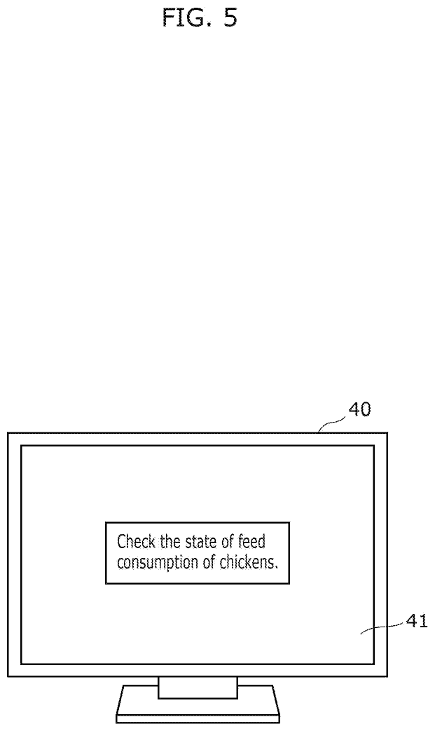

When the density deviation exceeds the first threshold (Yes in S17), or in other words, when it is estimated that the state of feed consumption of chickens is bad, monitor 32a causes communicator 31 to transmit image information for displaying an image showing that the state of feed consumption has worsened. Display device 40 receives the image information, and display 41 displays, based on the image information received, the image showing that the state of feed consumption has worsened (S18). FIG. 5 is a diagram illustrating an example of an image showing that the state of feed consumption has worsened. In other words, when the variation monitored by monitor 32a exceeds the first threshold, display 41 provides a notification indicating that the state of feed consumption has worsened by displaying an image as illustrated in FIG. 5.

On the contrary, when the density deviation is at most the first threshold (No in S17), or in other words, when the state of feed consumption of chickens is estimated to be favorable, the image showing that the state of feed consumption has worsened will not be displayed. In this case, display 41 may display an image showing that the state of feed consumption is favorable.

More specifically, the image showing that the state of feed consumption has worsened is displayed by display 41 when a state in which the density deviation exceeds the first threshold lasts for at least a certain period of time. That is, the image is displayed when the density deviation does not return below the first threshold for more than the certain period of time. The first threshold is empirically or experimentally determined by the installer etc. in an appropriate manner. The first threshold need not be a fixed threshold. The first threshold may be calculated, by calculator 32b, according to information indicating the state of growth of chickens, which will be described later.

Such first monitoring operation as has been described above can monitor the crowding state of chickens around feeders 50 in poultry house 100, and can provide a notification indicating that the crowding state has worsened when the crowding state of chickens around feeders 50 worsens.

### [Second Monitoring Operation]

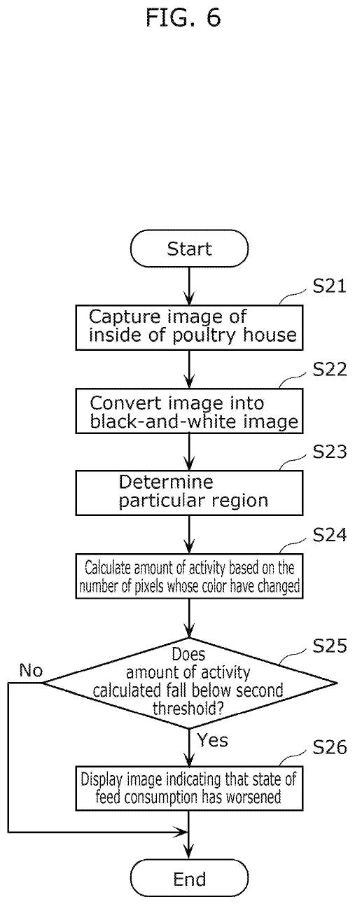

Furthermore, chickens that are active around feeders 50 are not only present around feeders 50, but are estimated to be consuming feed. Consequently, it is considered that the state of feed consumption is better as the amount of activity of the chickens around feeders 50 increases. Accordingly, poultry raising system 10 may monitor the amount of activity of chickens around feeders 50. Specifically, monitor 32a may calculate the amount of activity of chickens in a particular region by processing an image captured by imager 21, and monitor the calculated amount of activity. Hereinafter, such a second monitoring operation will be described in detail. FIG. 6 is a flowchart illustrating the second monitoring operation,

First, imager 21 of imaging device 20 captures an image of an inside of poultry house 100 (S21). Monitor 32a of information terminal 30 converts the image of the inside of poultry house 100 which is captured by imager 21 into a black-and-white image (S22), and determines at least part of the black-and-white image as a particular region (S23). These steps S21 through S23 are the same as steps S11 through S13 in FIG. 3. The particular region determined in step S23 is the same as the particular region determined in step S13.

Next, monitor 32a calculates the amount of activity based on the number of pixels which are included in the particular region of a black-and-white image to be processed and whose color have changed from an image that is one frame prior to the black-and-white image to be processed (S24). Specifically, monitor 32a compares the black-and-white image to be processed with a black-and-white image that is one frame prior to the black-and-white image to be processed, and counts the number of pixels which are included in the particular region and whose color has changed from the black-and-white image one frame prior to the black-and-white image to be processed. Here, the pixels whose color has changed includes both of (i) pixels whose color has changed from black to white and (ii) pixels whose color has changed from white to black. Monitor 32a calculates the number of pixels counted as the amount of activity. Note that monitor 32a may calculate, as the amount of activity, the proportion of the number of pixels counted with respect to the total number of pixels included in the particular region.

Next, monitor 32a determines whether the calculated amount of activity falls below a second threshold (S25). When the amount of activity falls below the second threshold (Yes in S25), or in other words, when it is estimated that the state of feed consumption of chickens is bad, monitor 32a causes communicator 31 to transmit image information for displaying an image showing that the state of feed consumption has worsened. Display device 40 receives the image information, and display 41 displays, based on the received image information, the image showing that the state of feed consumption has worsened (S26). In other words, when the amount of activity monitored by monitor 32a falls below the second threshold, display 41 provides a notification indicating that the state of feed consumption has worsened by displaying an image as illustrated in FIG. 5.

On the contrary, when the amount of activity is at least the second threshold (No in S25), or in other words, when the state of feed consumption of the chickens is estimated to be favorable, the image showing that the state of feed consumption has worsened will not be displayed. In this case, display 41 may display an image showing that the state of feed consumption is favorable.

More specifically, the image showing that the state of feed consumption has worsened is displayed by display 41 when a state in which the amount of activity falls below the second threshold lasts for at least a certain period of time, That is, the image is displayed when the amount of activity does not return above the second threshold for more than the certain period of time. The second threshold is empirically or experimentally determined by the installer etc. in an appropriate manner. The second threshold need not be a fixed threshold. The second threshold may be calculated, by calculator 32b, according to information indicating the state of growth of chickens, which will be described later.

Such second monitoring operation as has been described above can monitor the amount of activity of chickens around feeders 50 in poultry house 100, and can provide a notification indicating that the amount of activity has worsened when the amount of activity of the chickens around feeders 50 worsens,

### [Conclusion on State of Feed Consumption]

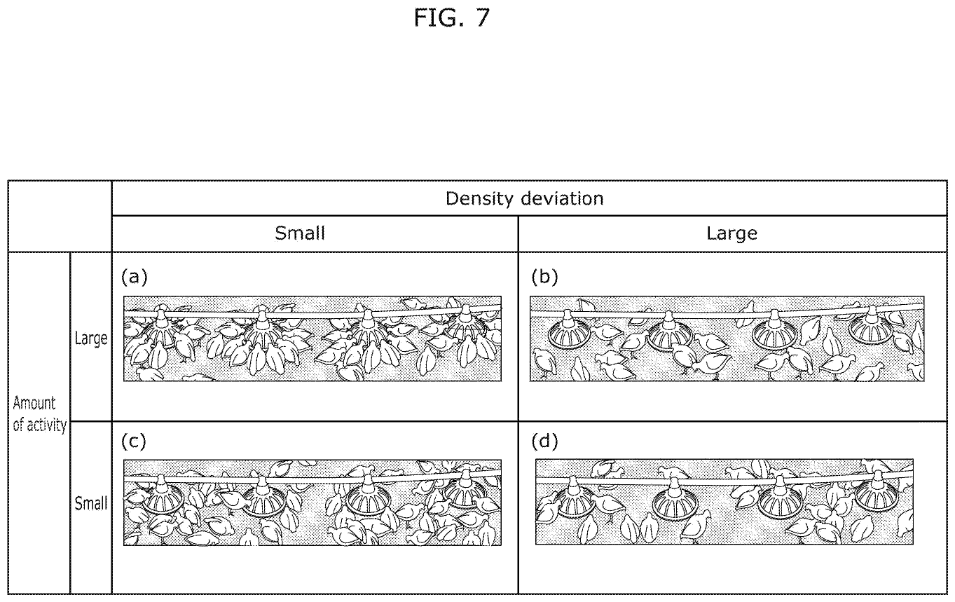

As has been described above, regular or periodic monitoring of the density deviation of chickens and the amount of activity of the chickens which is performed by monitor 32a makes it possible for poultry raising system 10 to estimate the state of feed consumption of the chickens in poultry house 100, FIG. 7 is a diagram illustrating various states of the chickens in poultry house 100.

As illustrated in (a) of FIG. 7, when the chickens are active and are uniformly distributed around feeders 50, the state of feed consumption is favorable. In this case, the density deviation is small, and the amount of activity is large.

As illustrated in (b) of FIG. 7, when the chickens are scatteringly moving around feeders 50, the state of feed consumption state is not so favorable. In this case, the density deviation is large, and the amount of activity is large.

As illustrated in (c) of FIG. 7, when a certain number of the chickens are crowded around feeders 50, but many of the chickens are sleeping, the state of feed consumption is not so favorable. In this case, the density deviation is small, and the amount of activity is small.

As illustrated in (d) of FIG. 7, when the chickens are not crowded around feeders 50, and are scattered and sleeping inside poultry house 100, the state of feed consumption is unfavorable. In this case, the density deviation is large, and the amount of activity is small.

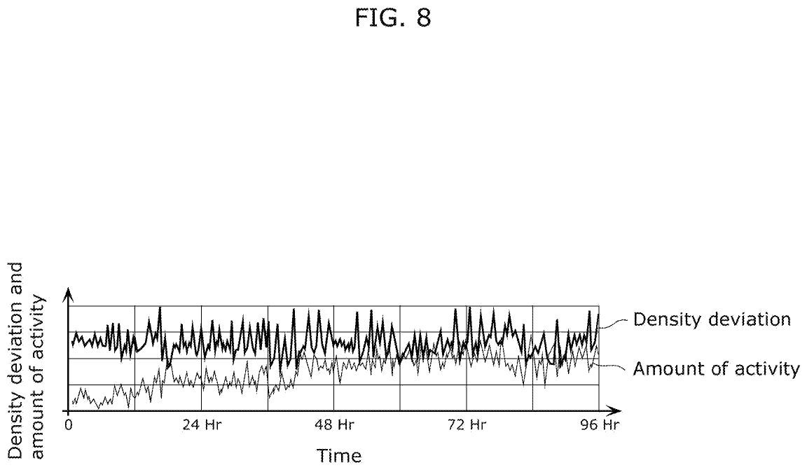

As has been described above, regular or periodic monitoring of the density deviation of the chickens and the amount of activity of the chickens which is performed by monitor 32a makes it possible for poultry raising system 10 to estimate the state of feed consumption of the chickens in poultry house 100. A time variation of a density deviation and an amount of activity monitored by monitor 32a are as illustrated in FIG. 8, for example. FIG. 8 is a diagram illustrating the time variation of a density deviation and an amount of activity. Note that monitor 32a may monitor the moving average of the density deviation and the moving average of the amount of activity.

### [Variation 1]

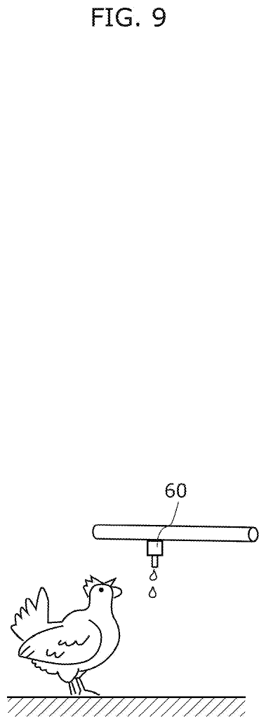

Although a region around feeders 50 is selectively determined to be a particular region in the aforementioned embodiment, a region around waterer 60 as illustrated in FIG. 9 may be selectively determined to be a particular region. FIG. 9 is a diagram schematically illustrating waterer 60. That is, the particular region is part of an image captured by imager 21, and includes a portion in which at least one of feeder 50 and waterer 60 is captured.

In addition, in the same manner as feeder 50, waterer 60 may have a color that is likely to be black when an image is converted into a binary image. That is, waterer 60 may have a color different from the color of chickens.

In addition, it is not essential for a particular region to include a portion in which at least one of feeder 50 and waterer 60 is captured. For example, when an anomaly occurred inside poultry house 100 is determined based on the crowding state of chickens in poultry house 100, the particular region need not include a portion in which feeder 50 and waterer 60 are captured.

### [Variation 2]

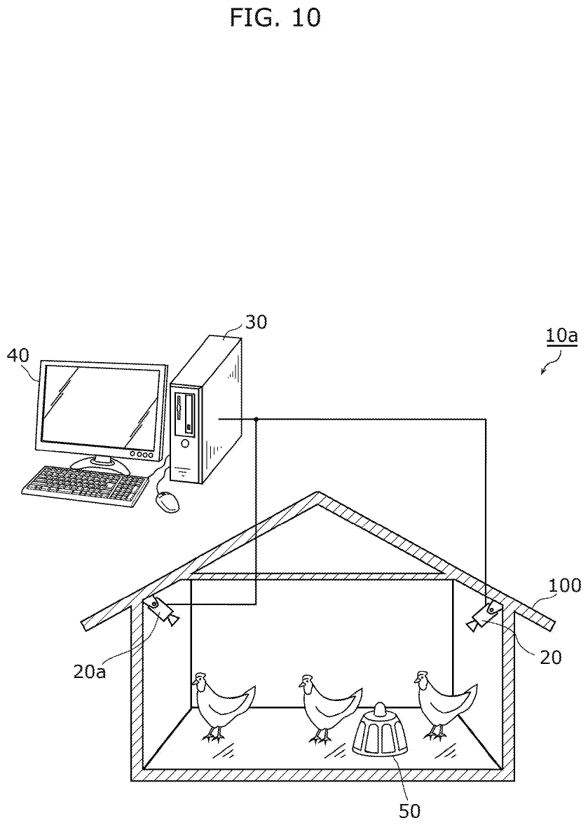

Poultry house 100 may include a plurality of imaging devices 20. FIG. 10 is a diagram schematically illustrating such a poultry raising system.

Poultry raising system 10a illustrated in FIG. 10 includes two imaging devices, which are imaging device 20 and imaging device 20a. That is, poultry raising system 10a includes a plurality of imaging devices. In such poultry raising system 10a, the aforementioned first monitoring operation and the aforementioned second monitoring operation are performed using, for example, each of an image captured by imaging device 20 and an image captured by imaging device 20a. Compared to poultry raising system 10, poultry raising system 10a can extend the area to be monitored inside poultry house 100.

### [Calculation Operation 1 for Calculating Threshold]

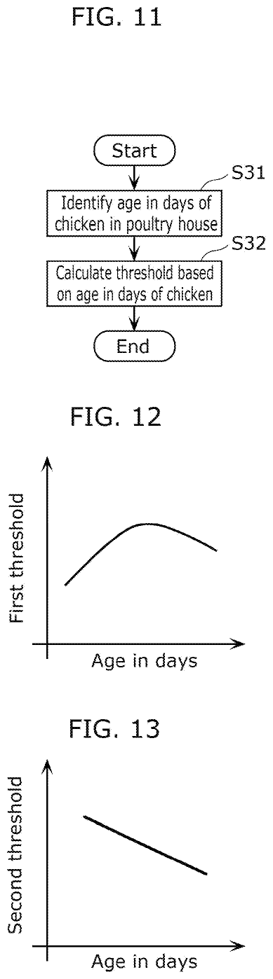

As has been described above, each of the first threshold and the second threshold (hereinafter, may also referred to as a threshold) may be a fixed threshold, or may be calculated by calculator 32b based on information indicating the state of growth of chickens in poultry house 100. The following describes an example in which a threshold is calculated, by calculator 32b, according to an age in days of chickens in a poultry house. FIG. 11 is a flowchart illustrating calculation operation 1 for calculating a threshold.

First, calculator 32b identifies an age in days of chickens in poultry house 100 (531). Calculator 32b can identify the age in days of the chickens in poultry house 100 by, for example, measuring the time elapsed since the time at which raising of the chickens inside poultry house 100 has started. The age in days of the chickens may be inputted through inputter 34.

Next, calculator 32b calculates a threshold based on the identified age in days of the chickens (532). Calculator 32b can determine (calculate) a threshold that corresponds to the identified age in days of the chickens using, for example, a relation between an age in days and a threshold, which is stored in storage 33 in advance. FIG. 12 is a diagram illustrating a relation between an age in days and a first threshold. FIG. 13 is a diagram illustrating a relation between an age in days and a second threshold.

According to the study conducted by the inventors, they have found out that a density deviation tends to be depicted as a bell-shaped curve as the age in days of chickens increases (the shape of such a curve is, however, a mere example; it is considered that the shape of a curve changes according to the state of poultry house 100, how a particular region is selected, the breed of chickens, a season, etc.). Consequently, as illustrated in FIG. 12, calculator 32b calculates a first threshold according to the age in days of chickens so as to reduce the above-mentioned tendency of the density deviation according to the age in days. This increases the accuracy of a notification since a first threshold is calculated to be an appropriate value according to the age in days of the chickens.

In addition, the amount of activity of chickens typically decreases as the age in days of the chickens increases. Consequently, as illustrated in FIG. 12, calculator 32b decreases a second threshold as the age in days of chickens increases. This increases the accuracy of a notification since a second threshold is calculated to be an appropriate value according to the age in days of chickens.

Note that FIG. 12 and FIG. 13 are diagrams each schematically illustrating the relation, and thus an accurate inclination (curve) of the relation is empirically or experimentally determined. In addition, instead of using the relation, table information indicating a connection between ages in days of chickens and thresholds may be used for the calculation of a threshold,

### [Calculation Operation 2 for Calculating Threshold]

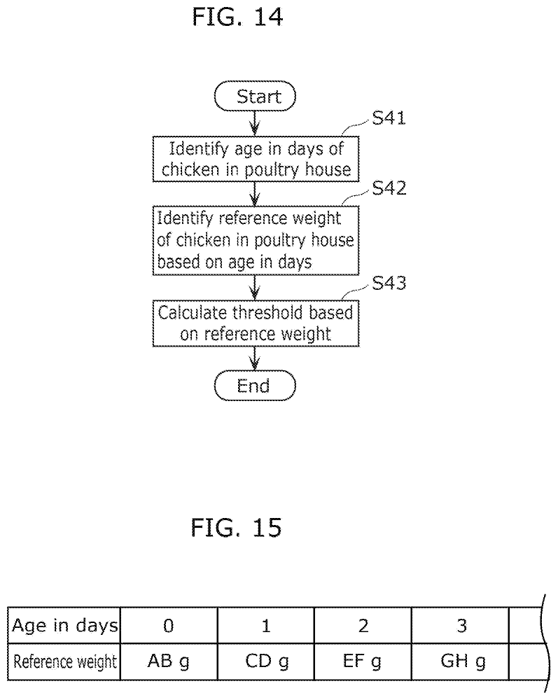

Calculator 32b may calculate a threshold based on weight information associating ages in days of a chicken with respective reference weights of the chicken for the ages in days. FIG. 14 is a flowchart illustrating calculation operation 2 for calculating a threshold.

First, calculator 32b identifies an age in days of chickens in poultry house 100 (S41), The method of identifying an age in days of the chickens in poultry house 100 is the same as the method employed in calculation operation 1 for calculating a threshold.

Next, calculator 32b identifies a reference weight of the chickens in poultry house 100 based on the age in days of the chickens in poultry house 100 and the weight information (542). FIG. 15 is a diagram illustrating an example of the weight information. Such weight information is stored in storage 33 in advance, and referred by calculator 32b, for example.

Reference weights in the weight information are ideal weights (target weights) for respective ages in days which are provided by the provider of chicks. However, the reference weights may be average weights (the measured average weights of chickens raised in poultry house 100) of chickens in every age in days which were raised in poultry house 100 in the past. Calculator 32b can identify the reference weight of chickens in poultry house 100 based on the age in days of the chickens in poultry house 100 which is identified in step S41 and the weight information.

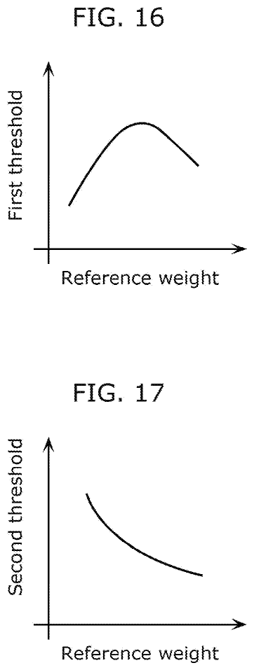

Next, calculator 32b calculates a threshold based on the identified reference weight (S43). Specifically, calculator 32b can determine (calculate) the threshold that corresponds to the identified age in days of the chicken using a relation between a reference weight and a threshold which is stored in storage 33 in advance. FIG. 16 is a diagram illustrating a relation between a reference weight and a first threshold. FIG. 17 is a diagram illustrating a relation between a reference weight and a second threshold.

According to the study conducted by the inventors, they have found out that a density deviation tends to be depicted as a bell-shaped curve as the reference weight of chickens increases (the shape of such a curve is, however, a mere example; it is considered that the shape of a curve changes according to the state of poultry house 100, how a particular region is selected, the breed of chickens, a season, etc.). Consequently, as illustrated in FIG. 16, calculator 32b calculates a first threshold according to the reference weight of chickens so as to reduce the above-mentioned tendency of the density deviation according to the age in days. This increases the accuracy of a notification since a first threshold is calculated to be an appropriate value according to the reference weight of the chickens.

In addition, the amount of activity of chickens typically decreases as the reference weight of the chickens increases. Consequently, as illustrated in FIG. 17, calculator 32b decreases a second threshold as the reference weight of the chickens increases. This increases the accuracy of a notification since a second threshold is calculated to be an appropriate value according to the reference weight of the chickens.

Note that FIG. 16 and FIG. 17 are diagrams each schematically illustrating the relation. An accurate inclination (curve) etc. of the relation is empirically or experimentally determined. In addition, instead of using the relation, table information indicating a connection between reference weights of chickens and thresholds may be used for the calculation of a threshold.

### [Calculation Operation 3 for Calculating a Threshold]

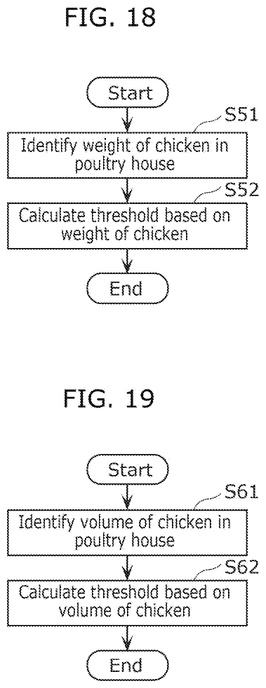

Although an age in days of chickens is used as the information indicating the state of growth of the chickens in calculation operation 1 and calculation operation 2, a measured value of the weight of the chickens may be used instead of an age in days of the chickens. FIG. 18 is a flowchart illustrating calculation operation 3 for calculating a threshold using such information.

First, calculator 32b identifies the weight of chickens in poultry house 100 (S51). Calculator 32b obtains, via communicator 31, the weight of the chickens from a scale (not illustrated) provided inside poultry house 100, for example. The weight of the chickens may be measured by, for example, a manager of poultry house 100, and may be inputted through inputter 34. Note that the identified weight of each chicken is, more specifically, the average weight (i.e., weight per chicken) of a plurality of chickens in poultry house 100.

Next, calculator 32b calculates a threshold based on the identified weight of the chickens (S52). Specifically, calculator 32b can determine (calculate) the threshold that corresponds to the identified weight of the chickens using a relation between a weight and a threshold which is stored in storage 33 in advance. The illustration of the relation is omitted. In addition, instead of using the relation, table information indicating a connection between weights of chickens and thresholds may be used for the calculation of a threshold.

According to the study conducted by the inventors, they have found out that a density deviation tends to be depicted as a bell-shaped curve as the weight of chickens increases (the shape of such a curve is, however, a mere example; it is considered that the shape of a curve changes according to the state of poultry house 100, how a particular region is selected, the breed of chickens, a season, etc.). Consequently, calculator 32b calculates a first threshold according to the weight of chickens so as to reduce the above-mentioned tendency of the density deviation according to the age in days. This increases the accuracy of a notification since a first threshold is calculated to be an appropriate value according to the weight of the chickens.

In addition, the amount of activity of the chickens typically decreases as the weight of the chickens increases. Consequently, calculator 32b decreases a second threshold as the weight of the chickens increases. This increases the accuracy of a notification since a second threshold is calculated to be an appropriate value according to the weight of the chickens.

### [Calculation Operation 4 for Calculating a Threshold]

As the information indicating the state of growth of chickens, the volume of the chickens may be used in calculation operation for calculating a threshold. FIG. 19 is a flowchart illustrating calculation operation 4 for calculating a threshold using such information.

First, calculator 32b identifies the volume of chickens in poultry house 100 (S61). Calculator 32b can identify (estimate) the volume of the chickens provided in poultry house 100 by, for example, performing image processing on an image captured by imager 21. Note that calculator 32b may identify the volume of the chickens in poultry house 100 based on the weight of the chickens in poultry house 100. The volume of the chicken may be measured by, for example, a manager of poultry house 100, and may be inputted through inputter 34. Note that the identified volume of the chickens is, more specifically, the average volume (i.e., volume per chicken) of a plurality of chickens in poultry house 100.

Next, calculator 32b calculates a threshold based on the identified volume of the chickens (S62). Specifically, calculator 32b can determine (calculate) the threshold that corresponds to the identified volume of the chickens using a relation between a volume and a threshold which is stored in storage 33 in advance. The illustration of the relation is omitted. In addition, instead of using the relation, table information indicating a connection between volumes of chickens and thresholds may be used for the calculation of a threshold.

According to the study conducted by the inventors, they have found out that a density deviation tends to be depicted as a bell-shaped curve as the volume of chickens increases (the shape of such a curve is, however, a mere example; it is considered that the shape of a curve changes according to the state of poultry house 100, how a particular region is selected, the breed of chickens, a season, etc.). Consequently, calculator 32b calculates a first threshold according to the volume of chickens so as to reduce the above-mentioned tendency of the density deviation according to the age in days. This increases the accuracy of a notification since a first threshold is calculated to be an appropriate value according to the weight of the chickens.

In addition, the amount of activity of the chickens typically decreases as the volume of the chickens increases. Consequently, calculator 32b decreases a second threshold as the volume of the chickens increases. This increases the accuracy of a notification since a second threshold is calculated to be an appropriate value according to the volume of the chickens.

### [Calculation Operation 5 for Calculating a Threshold]

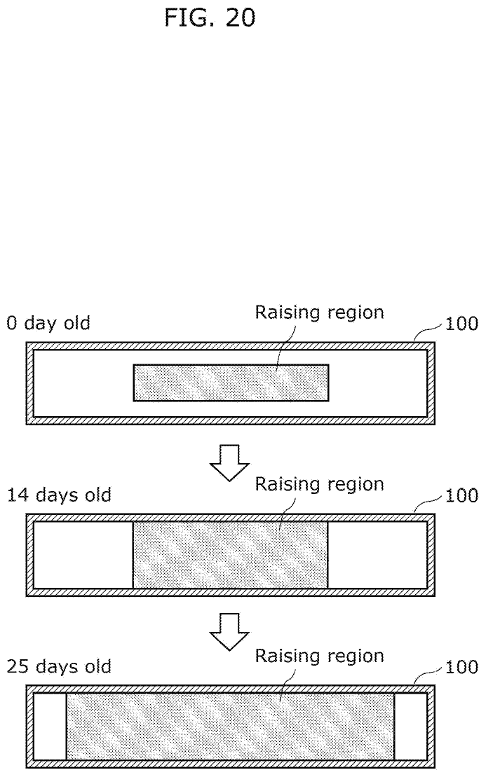

The area size of a raising region that is used for raising chickens in poultry house 100 may change according to ages in days of the chickens. FIG. 20 is a plan view illustrating the inside of poultry house 100 which is viewed from the above. Each of illustrated regions hatched with dots is a raising region. As illustrated in FIG. 20, the area size of a raising region increases as the age in days of chickens increases.

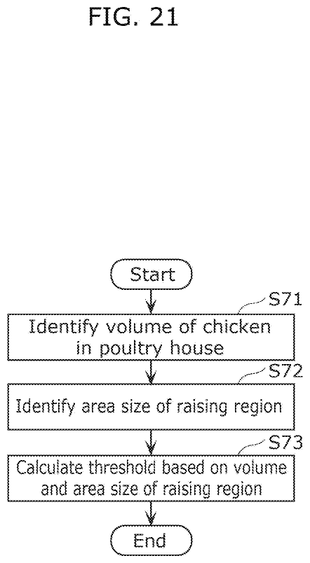

A calculation operation for calculating a threshold may be performed in consideration of the area size of such a raising region. For example, calculator 32b may calculate a threshold based on the volume of chickens in poultry house 100 and the area size of a raising region. FIG. 21 is a flowchart illustrating calculation operation 5 for calculating a threshold using such information.

First, calculator 32b identifies the volume of chickens in poultry house 100 (S71). The method of identifying the volume of the chickens is the same as the method employed in calculation operation 4 for calculating a threshold.

Next, calculator 32b identifies the area size of a raising region (S72). Calculator 32b can identify the area size of a raising region by, for example, performing image processing on an image captured by imager 21. The area size of a raising region may be inputted through inputter 34. In addition, if information indicating a connection between ages in days of chickens and area sizes of a raising region is stored in storage 33 in advance, calculator 32b can identify the age in days of chickens, and then identify the area size of a raising region based on the identified age in days of the chickens and the information stored in storage 33.

Next, calculator 32b calculates a threshold based on the volume of the chickens in poultry house 100 which is identified in step S61 and the area size of the raising region which is identified in step S62 (S73). More specifically, calculator 32b calculates a threshold based on the average volume per chicken in poultry house 100 and an occupancy area per chicken which is determined based on the area size of a raising region, Note that the occupancy area is determined by dividing the area size of a raising region by the number of chickens raised in a poultry house. For example, when the letter A denotes the volume per chicken in poultry house 100 and the letter B denotes the occupancy area per chicken, the formula A/B may denote a range in which one chicken can move around. The result of the formula A/B increases when the range in which one chicken can move around is small.

The density deviation of the chickens decreases as the result of the formula A/B increases. Consequently, calculator 32b decreases a first threshold as the result of the formula A/B increases. This increases the accuracy of a notification since a first threshold is calculated to be an appropriate value according to the volume of the chickens.

In addition, the amount of activity of the chickens decreases as the result of the formula A/B increases. Consequently, calculator 32b decreases a second threshold as the result of the formula A/B increases. This increases the accuracy of a notification since a second threshold is calculated to be an appropriate value according to the volume of the chickens.

The above has described calculation operation 1 through 5 for calculating a threshold. Note that thresholds each is changed at, for example, daily intervals; however, the thresholds each may be changed at every predetermined period of at least two days or at every predetermined period of less than a day.

### Advantageous Effects, Etc.

As has been described above, poultry raising system 10 includes: imager 21 that captures an image of an inside of poultry house 100; monitor 32a that monitors a feature quantity of chickens in poultry house 100 which is obtained by performing image processing on the image captured by imager 21; and calculator 32b that calculates, based on information indicating a state of growth of the chickens in poultry house 100, a threshold used for providing a notification about the chickens in poultry house 100. The notification is provided based on the feature quantity.

Such poultry raising system 10 can change, based on the state of growth of chickens in poultry house 100, the threshold used for providing a notification about the chickens in poultry house 100. Poultry raising system 10 can increase the accuracy of the notification about the chickens in poultry house 100 by appropriately changing the threshold.

In addition, the information indicating the state of growth is an age in days of the chickens in poultry house 100, and calculator 32b calculates the threshold based on the age in days of the chickens in poultry house 100, for example.

Such poultry raising system 10 can change, based on the age in days of the chickens in poultry house 100, the threshold used for providing the notification about the chickens in poultry house 100.

In addition, poultry raising system 10 further includes storage 33 that stores weight information associating ages in days of a chicken with respective reference weights of the chicken for the ages in days. Calculator 32b (i) identifies a reference weight of the chickens in poultry house 100, based on the age in days of the chickens in poultry house 100 and the weight information, and (ii) calculates the threshold based on the reference weight identified, for example.

Such poultry raising system 10 can change, based on the reference weight of the chickens in poultry house 100, the threshold used for providing the notification about the chickens in poultry house 100.

In addition, the information indicating the state of growth is a weight of the chickens in poultry house 100, and calculator 32b calculates the threshold based on the weight of the chickens in poultry house 100, for example.

Such poultry raising system 10 can change, based on the weight of the chickens in poultry house 100, the threshold used for providing the notification about the chickens in poultry house 100.

In addition, the information indicating the state of growth is a volume of the chickens in poultry house 100, and calculator 32b calculates the threshold based on the volume of the chickens in poultry house 100, for example.

Such poultry raising system 10 can change, based on the volume of the chickens in poultry house 100, the threshold used for providing the notification about the chickens in poultry house 100.

In addition, an area size of a raising region that is used for raising the chickens in poultry house 100 is changed according to an age in days of the chickens, and calculator 32b calculates the threshold based on the volume of the chickens in poultry house 100 and the area size of the raising region, for example.

Such poultry raising system 10 can change, based on the volume of the chickens in poultry house 100 and a raising region, the threshold used for providing the notification about the chickens in poultry house 100.

In addition, monitor 32a (0 calculates, for each of subregions obtained by dividing a particular region which is part of the image, a proportion of the subregion estimated to be occupied by at least a chicken, and (ii) monitors, as the feature quantity, a variation in the proportions calculated for the subregions, for example.

Such poultry raising system 10 can monitor the crowding state of the chickens in poultry house 100.

In addition, poultry raising system 10 further includes a notifier that provides the notification when the variation monitored by monitor 32a exceeds the threshold calculated, for example. The notifier is, for example, display 41 that provides a notification by displaying an image.

Such poultry raising system 10 can provide a notification indicating a rise in the density deviation of the chickens in poultry house 100.

In addition, monitor 32a (i) calculates an amount of activity of the chickens in poultry house 100 by performing the image processing, and (ii) monitors, as the feature quantity, the amount of activity calculated, for example.

Such poultry raising system 10 can monitor the amount of activity of the chickens in poultry house 100.

In addition, poultry raising system 10 further includes a notifier that provides a notification when the amount of activity monitored by monitor 32a falls below the threshold, for example. The notifier is, for example, display 41 that provides a notification by displaying an image.

Such poultry raising system 10 can provide a notification indicating a decrease in the amount of activity of the chickens in poultry house 100.

In addition, a poultry raising method that is executed by a computer, such as poultry raising system 10, includes: capturing an image of an inside of poultry house 100; monitoring a feature quantity of chickens in poultry house 100 which is obtained by performing image processing on the image captured; and calculating, based on information indicating a state of growth of the chickens in poultry house 100, a threshold used for providing a notification about the chickens in poultry house 100, The notification is provided based on the feature quantity.

Such a poultry raising method can change, based on the state of growth of the chickens in poultry house 100, the threshold used for providing a notification about the chickens in poultry house 100. The poultry raising method makes it possible to increase the accuracy of the notification about the chickens in poultry house 100 by appropriately changing the threshold.

### Other Embodiments

The above has described the poultry raising system according to the embodiments, yet the present invention is not limited to the above embodiments.

For example, the present invention may be implemented as a system targeted for diurnal poultry. Other than chickens, the diurnal poultry includes, for example, ducks, turkeys, or guinea fowls.

In addition, in the above embodiments, the poultry raising system is implemented as a system that includes a plurality of devices; however, the poultry raising system may be implemented as a single device or as a client-server system,

In addition, the assignment of structural elements included in the poultry raising system to the plurality of devices are an example. For example, a structural element included in one device may be included in another device. For example, an information terminal may include a display instead of a display device including the display, and the display device may be omitted.

In addition, these comprehensive or concrete embodiments of the present invention may be implemented by a device, a system, a method, an integrated circuit, a computer program, or a computer-readable recording medium such as a CD-ROM, or by any combination thereof. For example, the present invention may be implemented as a poultry raising method, a program for causing a computer to execute the poultry raising method, and a non-transitory recording medium on which the program is recorded.

In addition, in the above embodiment, a process that is performed by a specific processor may be performed by another processor. Furthermore, the order of a plurality of processes performed for the operation of the poultry raising system described in the above embodiments is an example. The order of the plurality of processes may be changed or performed in parallel.

In addition, in the above embodiments, the structural elements, such as an information processor, may be implemented by executing a software program suitable for each structural element. Each structural element may be implemented by means of a program executor, such as a CPU or a processor, reading and executing a software program recorded on a recording medium, such as a hard disk or a semiconductor memory.

In addition, each structural element, such as the information processor, may be implemented by a hardware product. Specifically, each structural element may be implemented by a circuit or an integrated circuit. These circuits may constitute a single circuit as a whole or may be individual circuits. Furthermore, each circuit may be a general-purpose circuit or may be a dedicated circuit.

The present invention also encompasses: embodiments achieved by applying various modifications conceivable to those skilled in the art to each embodiment; and embodiments achieved by optionally combining the structural elements and the functions of each embodiment without departing from the essence of the present invention.

### REFERENCE SIGNS LIST

10 10a poultry raising system
21 imager
32a monitor
32b calculator
33 storage
41 display (notifier)
100 poultry house

1. A poultry raising system, comprising:
an imager that captures an image of an inside of a poultry house;
a monitor that monitors a feature quantity of chickens in the poultry house, the feature quantity being obtained by performing image processing on the image captured by the imager; and
a calculator that calculates, based on information indicating a state of growth of the chickens in the poultry house, a threshold used for providing a notification about the chickens in the poultry house, the notification being provided based on the feature quantity.

2. The poultry raising system according to claim 1, wherein
the information indicating the state of growth is an age in days of the chickens in the poultry house, and
the calculator calculates the threshold based on the age in days of the chickens in the poultry house.

3. The poultry raising system according to claim 2, further comprising:
a storage that stores weight information associating ages in days of a chicken with respective reference weights of the chicken for the ages in days, wherein
the calculator:
identifies a reference weight of the chickens in the poultry house, based on the age in days of the chickens in the poultry house and the weight information; and
calculates the threshold based on the reference weight identified.

4. The poultry raising system according to claim 1, wherein
the information indicating the state of growth is a weight of the chickens in the poultry house, and
the calculator calculates the threshold based on the weight of the chickens in the poultry house.

5. The poultry raising system according to claim 1, wherein
the information indicating the state of growth is a volume of the chickens in the poultry house, and
the calculator calculates the threshold based on the volume of the chickens in the poultry house.

6. The poultry raising system according to claim 5, wherein
an area size of a raising region that is used for raising the chickens in the poultry house is changed according to an age in days of the chickens, and
the calculator calculates the threshold based on the volume of the chickens in the poultry house and the area size of the raising region.

7. The poultry raising system according to claim 1, wherein
the monitor:
calculates, for each of subregions obtained by dividing a particular region, a proportion of the subregion estimated to be occupied by at least a chicken, the particular region being part of the image; and
monitors, as the feature quantity, a variation in the proportions calculated for the subregions.

8. The poultry raising system according to claim 7, further comprising:
a notifier that provides the notification when the variation monitored by the monitor exceeds the threshold calculated.

9. The poultry raising system according to claim 1, wherein
the monitor:
calculates an amount of activity of the chickens in the poultry house by performing the image processing; and
monitors, as the feature quantity, the amount of activity calculated.

10. The poultry raising system according to claim 9, further comprising:
a notifier that provides a notification when the amount of activity monitored by the monitor falls below the threshold.

11. A poultry raising method, comprising:
capturing an image of an inside of a poultry house;
monitoring a feature quantity of chickens in the poultry house, the feature quantity being obtained by performing image processing on the image captured; and
calculating, based on information indicating a state of growth of the chickens in the poultry house, a threshold used for providing a notification about the chickens in the poultry house, the notification being provided based on the feature quantity.

12. A non-transitory computer-readable recording medium for use in a computer, the recording medium having a computer program recorded thereon for causing the computer to execute the poultry raising method according to claim 11.
